(19) United States
(12) Patent Application Publication
(10) Pub. No.: US 2026/0267573 A1
(43) Pub. Date: Sep. 10, 2026

(54) COMPUTER-READABLE STORAGE MEDIUM, METHOD, AND INFORMATION PROCESSING DEVICE FOR FACILITATING INSTALLATION OF SUPPORT PROGRAM FOR PRINTING PROGRAM

(71) Applicant: BROTHER KOGYO KABUSHIKI KAISHA, Nagoya (JP)

(72) Inventor: Kenju NARITA, Nagoya (JP)

(21) Appl. No.: 19/560,896

(22) Filed: Mar. 9, 2026

(30) Foreign Application Priority Data
Mar. 10, 2025 (JP) 2025-037442

(51) Int. Cl. G06F 3/12; G06F 3/04842; G06F 8/61

(52) U.S. Cl. CPC G06F 3/1225; G06F 3/04842; G06F 3/1204; G06F 3/1287; G06F 8/61

(57) ABSTRACT

A non-transitory computer-readable storage medium stores computer-readable instructions that are executable by a processor of an information processing device including a user interface and an operating system (OS). The computer-readable instructions are different from the OS and configured to, when executed by the processor, cause the information processing device to, in response to receiving a first operation via the user interface, perform a first process to install on the information processing device a support program configured to support an OS standard printing program.

### REFERENCE TO RELATED APPLICATIONS

This application claims priority from Japanese Patent Application No. 2025-037442 filed on Mar. 10, 2025. The entire content of the priority application is incorporated herein by reference.

### BACKGROUND ART

In recent years, a technology has been put into practical use that enables an information processing device to control a printing device by using an OS (i.e., an abbreviation for “Operating System”) standard printing program without using a device driver provided by a vendor of the printing device. In this technology, in response to detection of the printing device, the OS associates the printing device with the OS standard printing program. Thereafter, in response to receipt of a print instruction for the printing device, the information processing device generates print data by using the OS standard printing program without using the device driver provided by the vendor of the printing device. This arrangement enables printing by the OS standard printing program.

As a technology for controlling a printing device by using an OS standard printing function without using a device driver, there is known, for instance, a configuration in which a terminal device including a standard printer driver provided as a standard function of the OS installs a printing support application downloaded from a service on a network.

### SUMMARY

As described above, in the known configuration, a printing support application (hereinafter also referred to as a “support program” or an “auxiliary program”) configured to support printing by the OS standard printing program is downloaded and installed. In addition, when a new printing device is added as a target device to be controlled, a support program corresponding to the new printing device is automatically downloaded by the OS from a service such as an application store and installed. Accordingly, there is a need for a new technology for installing such a support program.

Aspects of the present disclosure are advantageous in providing one or more improved techniques for facilitating installation of a support program for an OS standard printing program.

According to aspects of the present disclosure, a non-transitory computer-readable storage medium is provided, which stores computer-readable instructions that are executable by a processor of an information processing device. The information processing device includes a user interface and an operating system (hereinafter referred to as an “OS”). The computer-readable instructions are different from the OS and configured to, when executed by the processor, cause the information processing device to receive a first operation via the user interface. The computer-readable instructions are further configured to, when executed by the processor, cause the information processing device to, in response to receiving the first operation via the user interface, perform a first process to install a support program on the information processing device. The support program is configured to support an OS standard printing program.

According to aspects of the present disclosure, further provided is a method implementable on a processor of an information processing device. The information processing device includes a user interface and an OS. The method includes receiving a first operation via the user interface. The method further includes performing, in response to receiving the first operation via the user interface, a first process to install a support program on the information processing device. The support program is configured to support an OS standard printing program.

According to aspects of the present disclosure, further provided is an information processing device that includes a user interface, and a controller including an OS. The controller is configured to receive a first operation via the user interface. The controller is configured to, in response to receiving the first operation via the user interface, perform a first process to install a support program on the information processing device. The support program is configured to support an OS standard printing program.

### BRIEF DESCRIPTION OF DRAWINGS

FIG. 1 is a block diagram illustrating a schematic configuration of a PC (i.e., an abbreviation for “Personal Computer”).

FIGS. 2A and 2B are flowcharts illustrating an example procedure of an installation setting process.

FIG. 3 is a flowchart illustrating an example procedure of a program selection process.

FIG. 4 illustrates an example of a first selection screen.

FIG. 5 illustrates an example of a second selection screen.

FIG. 6 illustrates an example of a third selection screen.

FIG. 7 illustrates an example of a fourth selection screen.

FIGS. 8A and 8B are flowcharts illustrating an example procedure of a selective installation process.

FIG. 9 is a flowchart illustrating an example procedure of a USB selective installation process.

FIGS. 10A and 10B are flowcharts illustrating an example procedure of an installation setting process.

FIG. 11 is a flowchart illustrating an example procedure of a USB selective installation process.

### DESCRIPTION

It is noted that various connections are described between elements in the following description. These connections, unless specified otherwise, may be either direct or indirect, and this specification is not intended to be limiting in that respect. Aspects of the present disclosure may be implemented using circuits (such as application-specific integrated circuits) or computer software stored on computer-readable media, including but not limited to RAMs, ROMs, flash memories, EEPROMs, CD media, DVD media, temporary storage, hard disk drives, floppy drives, permanent storage, and the like.

As used herein, the term “processor” encompasses a single processor or a group of multiple processors, which may include a single-core processor, a multi-core processor, multiple processors within a single device, or multiple processors in wired or wireless communication with each other. Such processors may be locally or remotely distributed and may operate collaboratively or in a distributed fashion across a network of devices, the Internet, or the cloud to collectively perform the tasks attributed to the “processor” described herein. Similarly, the term “non-transitory computer-readable storage medium” encompasses a single storage medium or a group of multiple storage media, which may be locally or remotely distributed and may collectively store and provide access to instructions, data, or other information in a coordinated or distributed manner.

In the present disclosure, an inclusive OR — meaning that it includes either A, B, or both — may be expressed as “A and/or B,” “at least one of A or B,” or “at least one selected from the group consisting of A and B.” Additionally, the expressions “one of A or B” and “either A or B,” as used herein, refer to a case where A or B is selected exclusively, but not both. The same interpretation applies in cases where three or more selectable elements are considered.

Hereinafter, programs and a control method using the programs in an illustrative embodiment according to aspects of the present disclosure will be described in detail with reference to the accompanying drawings. In the following description, programs incorporated into a PC (i.e., an abbreviation for “Personal Computer”) will be disclosed.

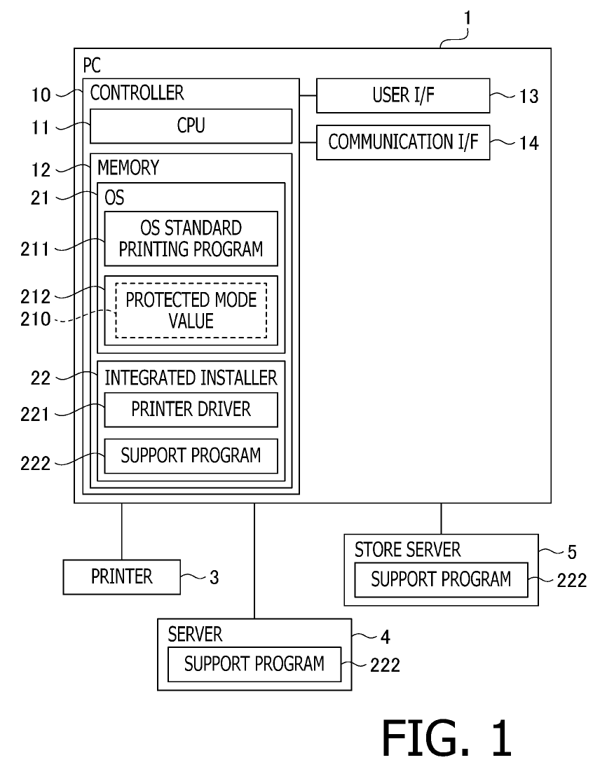

As illustrated in FIG. 1, a PC 1 of the illustrative embodiment includes a controller 10 that includes a CPU 11 and a memory 12. The PC 1 further includes a user I/F (i.e., an abbreviation for “interface”) 13 and a communication I/F 14, which are electrically connected to the controller 10. The PC 1 may be an example of an “information processing device” according to aspects of the present disclosure. Examples of the information processing device may include, but are not limited to, a tablet computer and a smartphone, in addition to the PC 1.

The CPU 11 is configured to perform various processes in accordance with programs read from the memory 12 and based on user operations. The memory 12 stores various programs and various types of data. The memory 12 may be used, for instance, as a work area when various programs are executed. Examples of the memory 12 may include, but are not limited to, a buffer provided in the CPU 11, and computer-readable storage media such as a CD-ROM, a DVD-ROM, and a USB flash drive. The CPU 11 may also use various programs and data read from a computer-readable storage medium.

The memory 12 stores various programs and various types of data, including an OS (i.e., an abbreviation for “Operating System”) 21 and an integrated installer 22. The integrated installer 22 may be an example of “computer-readable instructions” according to aspects of the present disclosure. Details of the programs and data will be described later. The controller 10 shown in FIG. 1 is a general term collectively referring to hardware and software used to control the PC 1, and may not necessarily represent a single piece of hardware actually present in the PC 1.

The user I/F 13 includes hardware configured to display screens for notifying the user of information and hardware configured to receive user operations. Examples of the hardware configured to display screens may include, but are not limited to, various types of displays such as a liquid crystal display and an organic EL display. The user I/F 13 may include at least one of a display, a mouse, or a keyboard. The user I/F 13 may include a touch panel having both the hardware configured to display screens and the hardware configured to receive user operations.

The communication I/F 14 includes hardware configured to communicate with external devices. The communication I/F 14 has functions compatible with communication standards such as Wi-Fi (“Wi‑Fi” is a registered trademark of the non-profit Wi-Fi Alliance), Ethernet (“Ethernet” is a registered trademark of Xerox Corporation), and USB. The PC 1 may include a plurality of communication I/Fs 14 compatible with a plurality of communication standards.

The PC 1 of the illustrative embodiment is connectable to a printer 3 via the communication I/F 14, as illustrated in FIG. 1. The printer 3 is a device having at least a printing function and a communication function. The printing function is a function of printing an image on a medium such as a sheet. A reading function is a function of reading an image from an original document. The printer 3 may be an example of a printing device according to aspects of the present disclosure. The term “printing device” may refer to any apparatus, device, or system configured to perform printing. Examples of the printing device include, but are not limited to, a copying machine, a multi-function peripheral, and a facsimile machine, in addition to the printer 3. A plurality of printing devices may be connected to the PC 1.

The OS 21 of the PC 1 is a multitasking OS configured to concurrently process a plurality of tasks by managing and switching between the tasks. In the illustrative embodiment, the OS 21 of the PC 1 is Windows (“Windows” is a registered trademark of Microsoft Corporation). The OS 21 includes a printing program 211, which is an OS standard printing program. That is, the PC 1 incorporates the OS 21 including the OS standard printing program 211.

The OS standard printing program 211 is a standard printer driver provided by a vendor of the OS 21 as part of the OS 21. The OS standard printing program 211 may also be referred to as a program installed as a standard component of the OS 21 or as a program pre-installed in the OS 21. For instance, the OS standard printing program 211 may be packaged together with the OS 21 and installed on the PC 1 together with the OS 21.

The OS standard printing program 211 is compatible with a plurality of models of printing devices provided by different vendors, and has functions for causing various printing devices to perform printing. The OS standard printing program 211 is a program, such as an IPP class driver, configured to communicate with various printing devices in accordance with IPP (i.e., an abbreviation for “Internet Printing Protocol”). The OS standard printing program 211 is further configured to support general functions that enable printing by various printing devices.

The OS standard printing program 211 further includes functions for, based on user instructions, receiving image data specified as print targets in print instructions output from various application programs and generating intermediate data based on the received image data. Examples of the intermediate data include, but are not limited to, XPS data. The OS standard printing program 211 further includes a function for, based on the intermediate data, generating print data in a format usable for printing by various printing devices. Examples of the print data include, but are not limited to, PWG Raster data and PDF data. The OS standard printing program 211 further includes a function for transmitting the generated print data to a printing device designated to perform printing using a communication function of the OS 21.

In addition, the OS 21 includes a protected mode in which the use of printer drivers provided by vendors of different printing devices is restricted. For instance, in response to a user operation, the OS 21 may accept a setting to enable or disable the protected mode. When the protected mode is enabled, the use of printer drivers provided by vendors of different printing devices is restricted. Examples of the protected mode include, but are not limited to, WPP (i.e., an abbreviation for “Windows Protected Print Mode”), which has been introduced in Windows 11.

When the protected mode is enabled, for instance, the use of all device drivers provided by vendors of image processing devices may be restricted. In another instance, the use of device drivers may be restricted for one or more functions while not restricted for other functions. In WPP, at least the use of printer drivers provided by vendors of printing devices is restricted. In the protected mode of the illustrative embodiment, in substantially the same manner as WPP, the OS 21 restricts the use of printer drivers but does not restrict the use of scanner drivers. Hereinafter, the term “printer driver” refers to a printer driver provided by a vendor of a printing device.

A setting value (hereinafter referred to as a “protected mode value”) 212 indicating whether the protected mode is enabled is stored, for instance, in a particular storage area 210 managed by the OS 21. Hereinafter, the expression “the protected mode value 212 is ON” means that the protected mode is enabled, and the expression “the protected mode value 212 is OFF” means that the protected mode is not enabled.

When the protected mode value 212 is changed from OFF to ON in a state where a printer driver provided by a vendor is installed on the PC 1, the OS 21 uninstalls the installed printer driver. The uninstallation of the printer driver may also be referred to as deletion of the printer driver. When the protected mode value 212 is ON, the OS 21 restricts the installation of printer drivers. However, even if the protected mode value 212 is ON, the OS 21 does not restrict the use of the OS standard printing program 211. That is, the OS standard printing program 211 remains usable regardless of the protected mode value 212. On the other hand, when the protected mode value 212 is OFF, the installation and use of various printer drivers are not restricted.

The integrated installer 22 is a program executable by the PC 1 and is distinct from the OS 21. The integrated installer 22 is a Win32 application provided by a vendor of the printer 3, and is configured to install on the PC 1 various programs for enabling the PC 1 to control the printer 3, in response to a user instruction. The integrated installer 22 is executed, for instance, when a printer 3 is newly connected to the PC 1.

As illustrated in FIG. 1, the integrated installer 22 of the illustrative embodiment includes, for instance, a printer driver 221 and a support program 222. The printer driver 221 is an example of a device driver for controlling the printer 3, and is provided by a vendor of the printer 3 and specific to the printer 3. The printer driver 221 is, for instance, a program configured to cause the printer 3 to perform printing and to support various functions of the printer 3. In contrast, unlike a printer driver specific to each printing device, the OS standard printing program 211 included in the OS 21 does not support functions specific to each printing device or each printer driver, particularly functions requiring complex processing. It is noted that the PC 1 does not use the printer driver 221 when performing printing using the OS standard printing program 211.

The support program 222 is a program or a group of programs configured to support processing by the OS standard printing program 211 included in the OS 21, in cooperation with the OS standard printing program 211. For instance, the support program 222 may be an application program provided by the vendor of the printer 3 and configured to support control of the printer 3 by the OS standard printing program 211. When the support program 222 is installed on the PC 1, the OS standard printing program 211 may, for instance, activate the support program 222 corresponding to the printer 3 in response to receipt of a selection of the printer 3, of an instruction for print settings related to printing by the printer 3, or of a print instruction to cause the printer 3 to perform printing. The support program 222 may also be referred to as a “PSA” (i.e., an abbreviation for “Print Support App”) or an “HSA” (i.e., an abbreviation for “Hardware Support Application”).

The support program 222 may be a combination of a plurality of programs, each configured to receive an execution instruction, or may be a single program configured to execute different processes in response to different instructions. The support program 222 may be compatible with two or more printers. For instance, a vendor may provide the support program 222 for each type of printer. For instance, separate support programs may be provided for an inkjet printer and for a laser printer. In addition to or instead of being provided for each type of printer, the support program 222 may be provided for each printer model or for each series of printer models.

As illustrated in FIG. 1, the PC 1 may be connectable to a server 4 operated by the vendor of the printer 3. The PC 1 may further be connectable to a store server 5 operated by Microsoft ("Microsoft" is a registered trademark of Microsoft Corporation). The server 4 and the store server 5 store various programs in a state ready for supply, and are configured to receive requests for programs from various devices and to supply installers of the requested programs in response. The server4 stores the support program 222 prepared by the vendor of the printer 3 in a state ready for supply. The store server 5 stores the support program 222 prepared by the vendor of the printer 3 in a state ready for supply. The support program 222 stored in the server 4 and the support program 222 stored in the store server 5 are substantially the same as the support program 222 included in the integrated installer 22.

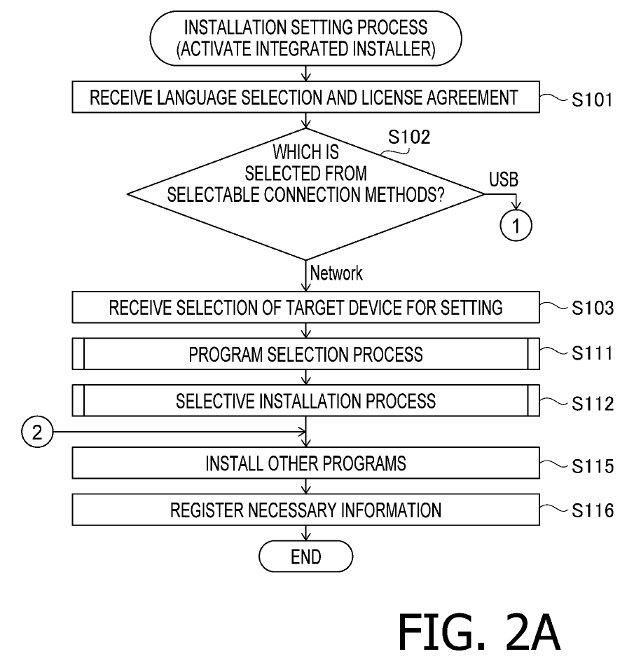

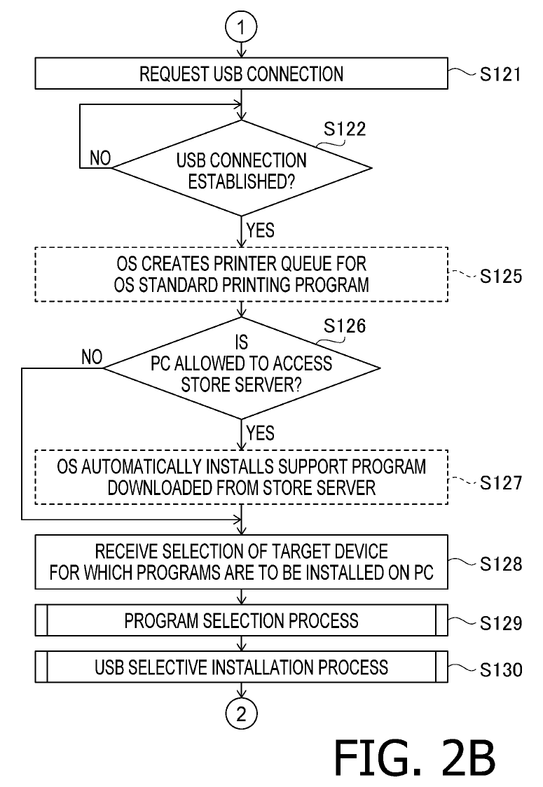

Subsequently, an installation setting process performed by the integrated installer 22 in the PC 1 of the illustrative embodiment will be described with reference to FIGS. 2A and 2B. The installation setting process is performed by the CPU 11 of the PC 1 in response to an activation instruction for the integrated installer 22. It is noted that, in the illustrative embodiment, each process other than user operations generally represents processing performed by the CPU 11 in accordance with instructions described in programs such as the integrated installer 22. The processing by the CPU 11 includes hardware control using an API of the OS 21. The operations of each program may hereinafter be described without detailed descriptions of the OS 21.

In the installation setting process, the CPU 11 first receives a language selection and a license agreement as initial settings (S101). Thereafter, the CPU 11 receives a selection of a connection method for connecting the PC 1 to the printer 3 (S102). If the license agreement is not received, the CPU 11 terminates the installation setting process without proceeding to S102.

In S102, the CPU 11 causes the user I/F 13 to display a screen that presents options such as wireless LAN, wired LAN, and USB as selectable connection methods for connecting the PC 1 to the printer 3. The CPU 11 then receives a user selection of one of these connection methods. In response to determining that a network connection using either a wireless LAN or a wired LAN has been selected (S102: Network), the CPU 11 proceeds to S103 to receive a selection of a target device for setting. Specifically, the CPU 11 searches for printers via the selected network, displays a list of the printers found, and receives a user selection of a printer from the list. Here, it is assumed that the printer 3 is selected.

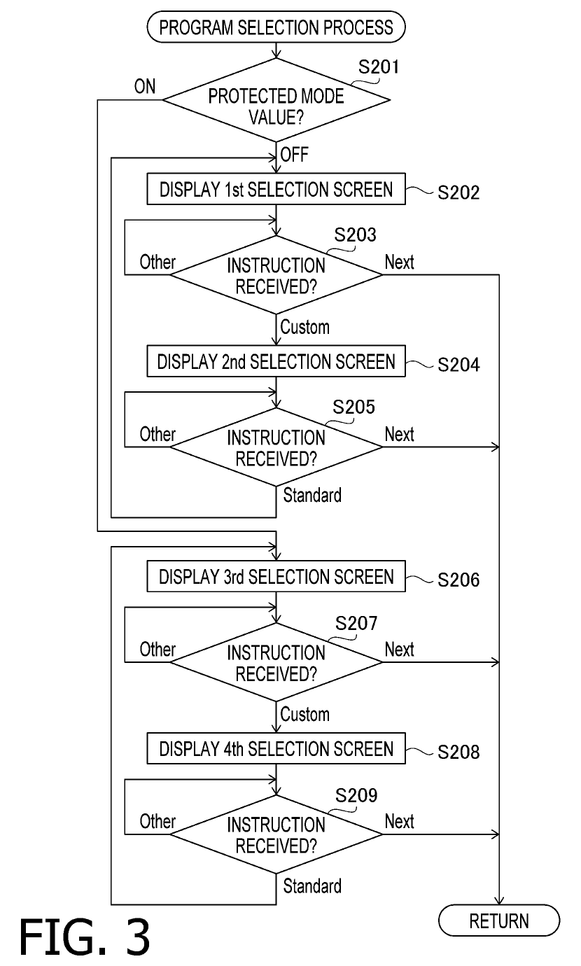

The CPU 11 then proceeds to S111 to perform a program selection process for selecting programs to be installed. A procedure of the program selection process will be described with reference to FIG. 3.

In the program selection process, the CPU 11 first determines whether the protected mode value 212 is ON or OFF (S201). For instance, the CPU 11 may access the storage area 210 (see FIG. 1) in which the protected mode value 212 is stored, thereby acquiring the protected mode value 212. In another instance, when the OS 21 provides an API for acquiring the protected mode value 212, the CPU 11 may inquire of the OS 21 through the API, thereby acquiring the value based on a response from the OS 21.

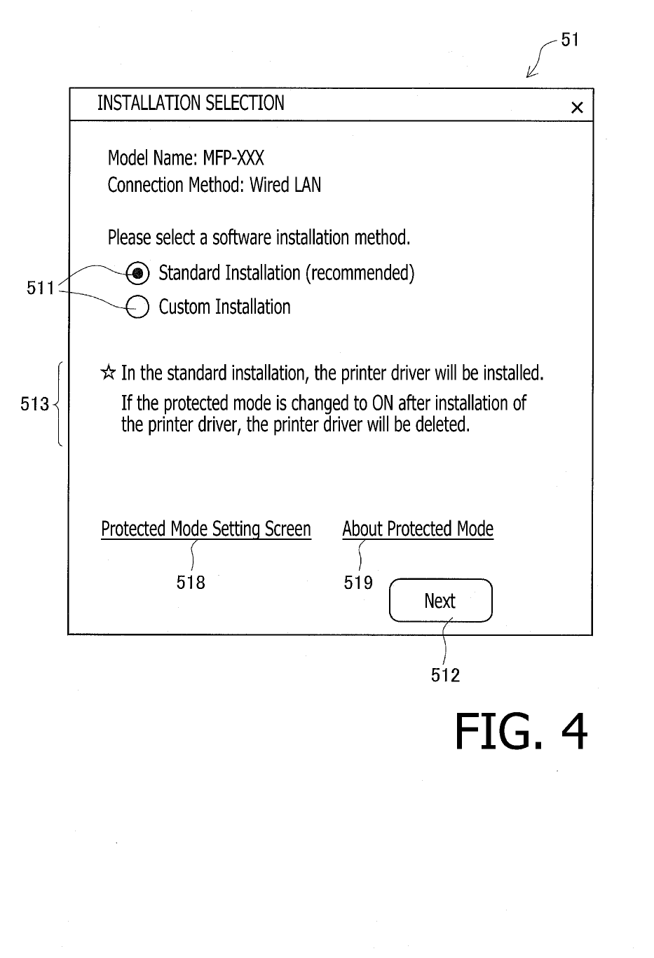

In response to determining that the protected mode value 212 is OFF (S201: OFF), the CPU 11 proceeds to S202 to cause the user I/F 13 to display a first selection screen. For instance, as illustrated in FIG. 4, the CPU 11 causes the user I/F 13 to display the first selection screen 51 including radio buttons 511, a “Next” button 512, a link 518 to “Protected Mode Setting Screen,” and a link 519 to “About Protected Mode.”

In response to an operation on the link 518 to “Protected Mode Setting Screen,” the CPU 11 requests the OS 21 to activate an OS setting screen. The OS setting screen is configured to receive an instruction to switch the protected mode value 212. When the OS 21 is requested to display the OS setting screen, after the OS setting screen is closed, the CPU 11 may return to S201 to determine again whether the protected mode value 212 is ON or OFF. Further, in response to an operation on the link 519 to “About Protected Mode,” the CPU 11 activates a web browser and causes the web browser to display a web page including an explanation of the protected mode.

The radio buttons 511 are configured to receive an exclusive selection between a standard installation and a custom installation. The standard installation is a method in which the integrated installer 22 automatically selects programs to be installed. The custom installation is a method in which a user selects programs to be installed via the user I/F 13. It is noted that, in the first execution of S202 after receiving a selection of the target device for setting in S103 of FIG. 2A, the CPU 11 causes the user I/F 13 to display the first selection screen 51 with the radio buttons 511 presented in a state where the standard installation is selected.

The “Next” button 512 on the first selection screen 51 is configured to receive an instruction to confirm the selection currently made on the first selection screen 51 and proceed to the next step. In response to an operation on the “Next” button 512, the CPU 11 determines that the programs selected at that time are to be installed and starts processing for their installation.

After displaying the first selection screen 51 in S202, the CPU 11 determines whether or not a radio button 511 or the “Next” button 512 has been operated (S203). The CPU 11 then waits until it receives an operation on either one. In response to an operation on an object other than the radio buttons 511 and the “Next” button 512 (S203: Other), the CPU 11 may change the display screen based on the user operation. For instance, the first selection screen 51 may include a link for displaying information about the protected mode. In this case, in response to an operation on the link, the CPU 11 may cause the user I/F 13 to display a particular web page indicated by the link.

As described above, when the protected mode value 212 is OFF, the PC 1 may receive installation of the printer driver 221 specific to the printer 3. In this case, the integrated installer 22 is configured to select, in the standard installation, the printer driver 221 as a program to be installed (hereinafter, which may be referred to as an “installation target”). Compared to the support program, the printer driver 221 has fewer restrictions and is more likely to enable preferable control of the printer 3. Accordingly, in the standard installation when the protected mode value 212 is OFF, the printer driver 221 is selected as an installation target, which is expected to allow the various capabilities of the printer 3 to be effectively utilized.

However, when the protected mode value 212 is changed from OFF to ON after the printer driver 221 has been installed, the installed printer driver 221 is automatically uninstalled. Once the printer driver 221 is uninstalled, the PC 1 uses the OS standard printing program 211 for printing with the printer 3. As described above, although the OS standard printing program 211 is compatible with various printers, it does not necessarily fully support the functions of the printer 3.

Accordingly, the CPU 11 displays a notification message 513 on the first selection screen 51, for instance, as illustrated in FIG. 4. The notification message 513 notifies the user that the printer driver 221 is to be installed when the standard installation is selected.

Further, through the notification message 513 on the first selection screen 51, the CPU 11 notifies the user that if the protected mode value 212 is changed from OFF to ON after the printer driver 221 has been installed, the printer driver 221 will be deleted. The notification message 513 displayed on the first selection screen 51 enables the user to recognize, in advance, risks associated with changing the protected mode value 212 from OFF to ON. The CPU 11 may provide an additional notification that certain functions become unavailable when the printer driver 221 is uninstalled.

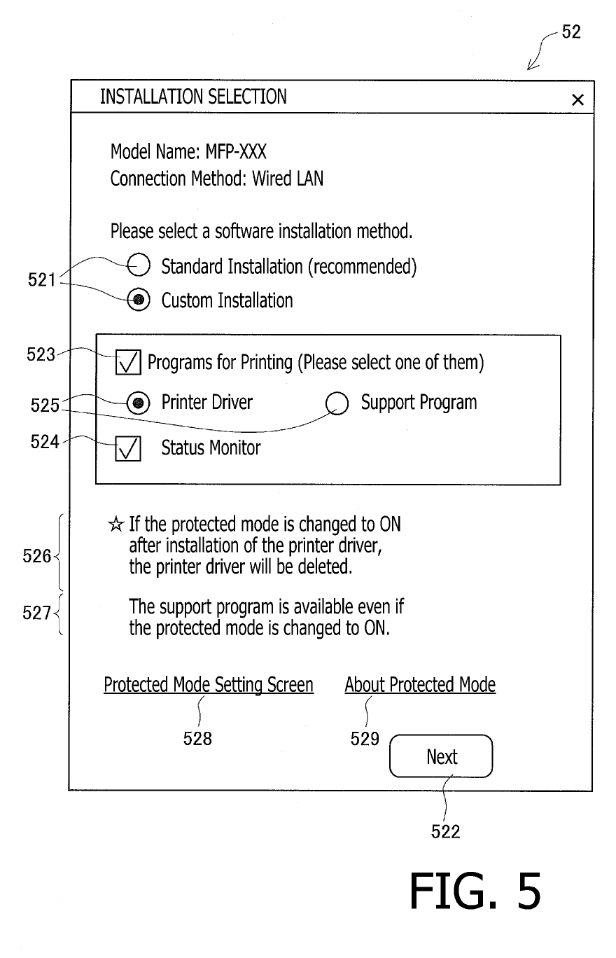

In response to determining that an instruction to select the custom installation has been received through an operation on the corresponding radio button 511 on the first selection screen 51 being displayed (S203: Custom), the CPU 11 causes the user I/F 13 to display a second selection screen (S204). For instance, as illustrated in FIG. 5, the second selection screen is configured to receive individual selections of programs to be installed on the PC 1 through user operations.

As illustrated in FIG. 5, the second selection screen 52 includes radio buttons 521, a “Next” button 522, checkboxes 523 and 524, radio buttons 525, a link 528 to “Protected Mode Setting Screen,” and a link 529 to “About Protected Mode.” The links 528 and 529 are substantially the same as the links 518 and 519 on the first selection screen 51, respectively.

The radio buttons 521 are configured to receive an exclusive selection between the standard installation and the custom installation, in substantially the same manner as the radio buttons 511 on the first selection screen 51. In substantially the same manner as the “Next” button 512 on the first selection screen 51, the “Next” button 522 is configured to receive an instruction to confirm one or more programs currently selected for installation on the second selection screen 52 and to proceed to the next step.

The checkboxes 523 and 524 are configured to receive individual selection instructions for various installable programs. In FIG. 5, only two types of programs are illustrated as selectable installation targets, namely a program for printing (the printer driver 221 or the support program 222) and a status monitor. However, additional programs may be installable by the integrated installer 22. For instance, when the printer 3 has a scanning function or a fax communication function, a scanner driver or a program for fax communication may be selectable. In that case, a checkbox may be provided on the second selection screen 52 for each selectable program.

The radio buttons 525 become operable when the checkbox 523 is used to select the program for printing as an installation target. The radio buttons 525 are configured to receive an exclusive selection between the printer driver 221 and the support program 222. That is, the second selection screen 52 is configured to receive an operation to exclusively select either the support program 222 or the printer driver 221 as an installation target. The support program 222 and the printer driver 221 are not usable together. Accordingly, the receipt of an exclusive selection makes it possible to inhibit the concurrent selection of both programs that are not usable together.

In the first execution of S204 after the custom installation has been selected in S203, the CPU 11 causes the user I/F 13 to display the second selection screen 52 with all the selectable programs checked and the printer driver 221 selected as the program for printing, for instance, as illustrated in FIG. 5.

The CPU 11 determines whether or not a radio button 521 or the “Next” button 522 on the second selection screen 52 has been operated (S205). The CPU 11 then waits until it receives an operation on either one. In response to an operation on an object other than the radio buttons 521 and the “Next” button 522 (S205: Other), the CPU 11 changes the display screen based on the user operation. For instance, in response to receiving operations on one or both of the checkboxes 523 and 524, the CPU 11 changes the selection state of each corresponding program.

When an operation on the checkbox 523 results in the program for printing being unselected, the CPU 11 disables the radio buttons 525 and sets a state in which neither the printer driver 221 nor the support program 222 is selected.

On the second selection screen 52, the CPU 11 may further display a notification message 526. The notification message 526 notifies the user that if the protected mode value 212 is changed from OFF to ON after the printer driver 221 has been installed, the printer driver 221 will be deleted. This notification informs the user that the printer driver 221 becomes unavailable when the protected mode value 212 is changed to ON, thereby enabling the user to recognize risks associated with changing the protected mode value 212 to ON after installation of the printer driver 221. The CPU 11 may display the notification message 526 only when the printer driver 221 is selected as an installation target. Further, on the second selection screen 52, the CPU 11 may also display a message 527 notifying that the support program 222 is not deleted even if the protected mode value 212 is changed from OFF to ON.

In response to determining that an instruction to select the standard installation has been received through an operation on the corresponding radio button 521 on the second selection screen 52 (S205: Standard), the CPU 11 returns to S202 to cause the user I/F 13 to display the first selection screen 51 shown in FIG. 4 again. When the protected mode value 212 is OFF, the CPU 11 repeats S202 to S205 until either the “Next” button 512 on the first selection screen 51 or the “Next” button 522 on the second selection screen 52 is operated.

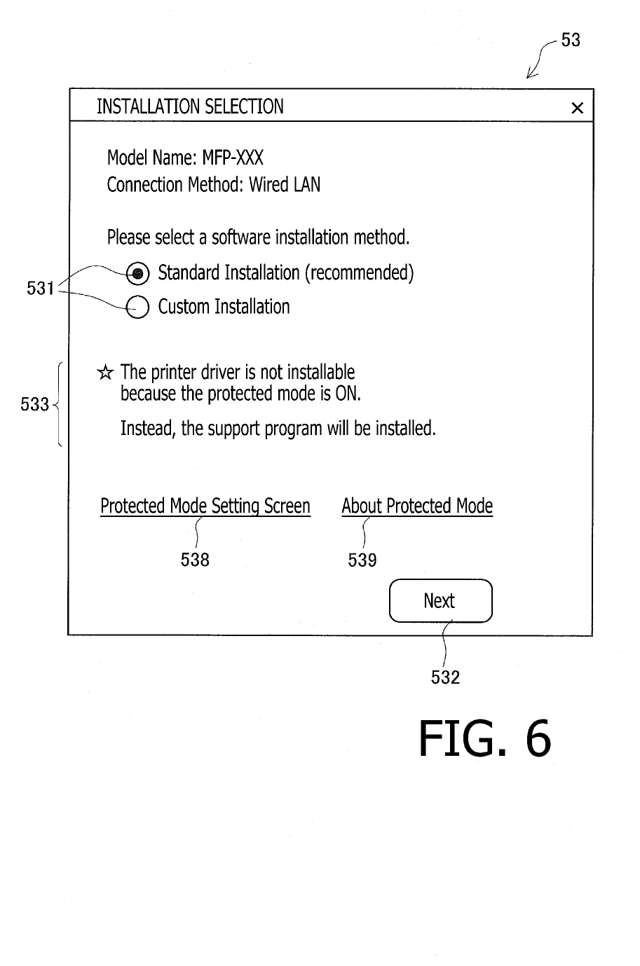

Meanwhile, in response to determining that the protected mode value 212 is ON (S201: ON), the CPU 11 causes the user I/F 13 to display a third selection screen (S206). For instance, as illustrated in FIG. 6, the third selection screen 53 includes radio buttons 531, a “Next” button 532, a link 538 to “Protected Mode Setting Screen,” and a link 539 to “About Protected Mode.” The links 538 and 539 are substantially the same as the links 518 and 519 on the first selection screen 51, respectively.

The radio buttons 531 are configured to receive an exclusive selection between the standard installation and the custom installation. In the first execution of S206 after S103 of FIG. 2A, the CPU 11 causes the user I/F 13 to display the third selection screen 53 with the radio buttons 531 presented in a state where the standard installation is selected. The “Next” button 532, in substantially the same manner as the “Next” button 512 on the first selection screen 51, is configured to receive an instruction to confirm the installation target program based on the current selection on the third selection screen 53 and proceed to the next step.

The CPU 11 determines whether or not a radio button 531 or the “Next” button 532 on the third selection screen 53 has been operated (S207). The CPU 11 then waits until it receives an operation on either one. In response to an operation on an object other than the radio buttons 531 and the “Next” button 532 (S207: Other), the CPU 11 may change the display screen based on the user operation.

When the protected mode value 212 is ON, the CPU 11 is unable to install the printer driver 221. The integrated installer 22 is configured to select the support program 222 as an installation target in the standard installation when the protected mode value 212 is ON. Installing the support program 222 when the protected mode value 212 is ON provides more available functions of the printer 3 than when only the OS standard printing program 211 is used.

Accordingly, on the third selection screen 53, the CPU 11 further displays a notification message 533. The notification message 533 notifies the user that the support program 222 is to be installed when the standard installation is selected.

Through the notification message 533 on the third selection screen 53, the CPU 11 further notifies the user that the printer driver 221 is not installable because the protected mode value 212 is ON. The notification that the printer driver 221 is unavailable when the protected mode value 212 is ON enables the user to understand the reason why the printer driver 221 is not selectable as an installation target. The CPU 11 may further notify the user, via the third selection screen 53, of a procedure for changing the protected mode value 212 to OFF. The CPU 11 may further notify the user, via the third selection screen 53, that the support program 222 serves as an alternative to the printer driver 221.

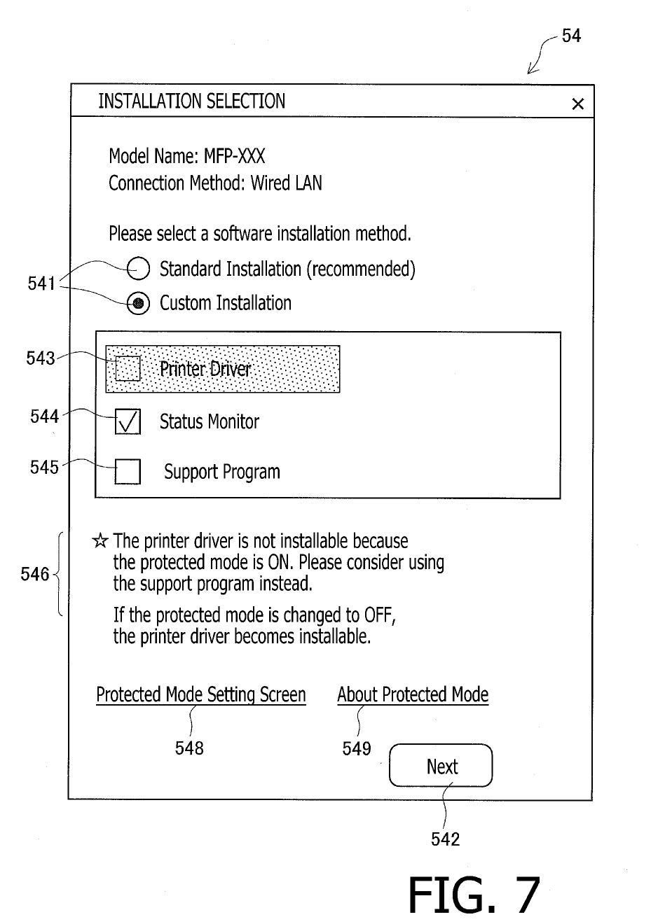

In response to determining that an instruction to select the custom installation has been received through an operation on the radio button 531 on the third selection screen 53 being displayed (S207: Custom), the CPU 11 causes the user I/F 13 to display a fourth selection screen (S208), for instance, as illustrated in FIG. 7. The fourth selection screen 54 is configured to receive individual selections of programs to be installed on the PC 1 through user operations. As illustrated in FIG. 7, the fourth selection screen 54 includes radio buttons 541, a “Next” button 542, checkboxes 543, 544, and 545, a link 548 to “Protected Mode Setting Screen,” and a link 549 to “About Protected Mode.” The links 548 and 549 are substantially the same as the links 518 and 519 on the first selection screen 51, respectively.

The radio buttons 541 are configured to receive an exclusive selection between the standard installation and the custom installation, in substantially the same manner as the radio buttons 511 on the first selection screen 51. The “Next” button 542, in substantially the same manner as the “Next” button 512 on the first selection screen 51, is configured to receive an instruction to confirm the programs currently selected for installation and proceed to the next step. The checkboxes 543 to 545 are configured to receive individual selection instructions for various installable programs.

When the protected mode value 212 is ON, the printer driver 221 is not installable. Accordingly, in this case, the CPU 11 does not receive selection of the printer driver 221. For instance, the CPU 11 may gray out the checkbox 543 for selecting the printer driver 221 to render it unselectable, or may inhibit the user I/F 13 from displaying a character string indicating the printer driver 221, or the checkbox 543. In another instance, although the CPU 11 may allow the user I/F 13 to display the checkbox 543, the CPU 11 may, in this case, cause the user I/F 13 to display an error message indicating that the printer driver 221 associated with the checkbox 543 is unselectable, in response to an operation on the checkbox 543. When the protected mode value 212 is ON, disabling selection of the printer driver 221 makes it possible to inhibit execution of unnecessary processing.

Meanwhile, even when the protected mode value 212 is ON, the support program 222 is installable. When the protected mode value 212 is ON, the CPU 11 displays a checkbox 545 for selecting the support program 222 as a program to be installed, thereby enabling selection of the support program 222. When the support program 222 is installed on the PC 1, functions not supported by the OS standard printing program 211 become available.

In the first execution of S208 after the custom installation has been selected in S207, the CPU 11 causes the user I/F 13 to display the fourth selection screen 54, for instance, as illustrated in FIG. 7, in a state where all selectable programs other than the printer driver 221 and the support program 222 are checked and neither the printer driver 221 nor the support program 222 is selected.

The CPU 11 determines whether or not a radio button 541 or the “Next” button 542 on the fourth selection screen 54 has been operated (S209). The CPU 11 then waits until an operation on either one is received. In response to an operation on an object other than the radio buttons 541 and the “Next” button 542 (S209: Other), the CPU 11 causes the user I/F 13 to display a screen modified based on the user operation.

It is noted that, in the first execution of S208 after the custom installation has been selected in S207, the CPU 11 may, in another instance, display the fourth selection screen 54 with the support program 222 selected.

On the fourth selection screen 54, the CPU 11 further displays a notification message 546. For instance, the notification message 546 notifies the user that the printer driver 221 is not installable because the protected mode value 212 is ON. Through the notification message 546, the CPU 11 may further notify the user that installation of the support program 222 is recommended and/or that the printer driver 221 becomes installable when the protected mode value 212 is changed from ON to OFF.

In response to determining that an instruction to select the standard installation has been received through an operation on the corresponding radio button 541 (S209: Standard), the CPU 11 proceeds to S206 to cause the user I/F 13 to display the third selection screen 53 shown in FIG. 6 again. In this case, even if the support program 222 has not been selected as an installation target on the fourth selection screen 54, the support program 222 is selected as an installation target when the third selection screen 53 is displayed. When the protected mode value 212 is ON, the CPU 11 repeats S206 to S209 until either the “Next” button 532 on the third selection screen 53 or the “Next” button 542 on the fourth selection screen 54 is operated.

In response to determining that a “Next” button (any one of 512, 522, 532, or 542) on a currently displayed screen has been operated (S203, S205, S207, or S209: Next), the CPU 11 determines the programs currently selected on the screen as installation targets. The CPU 11 then ends the program selection process and returns to the installation setting process.

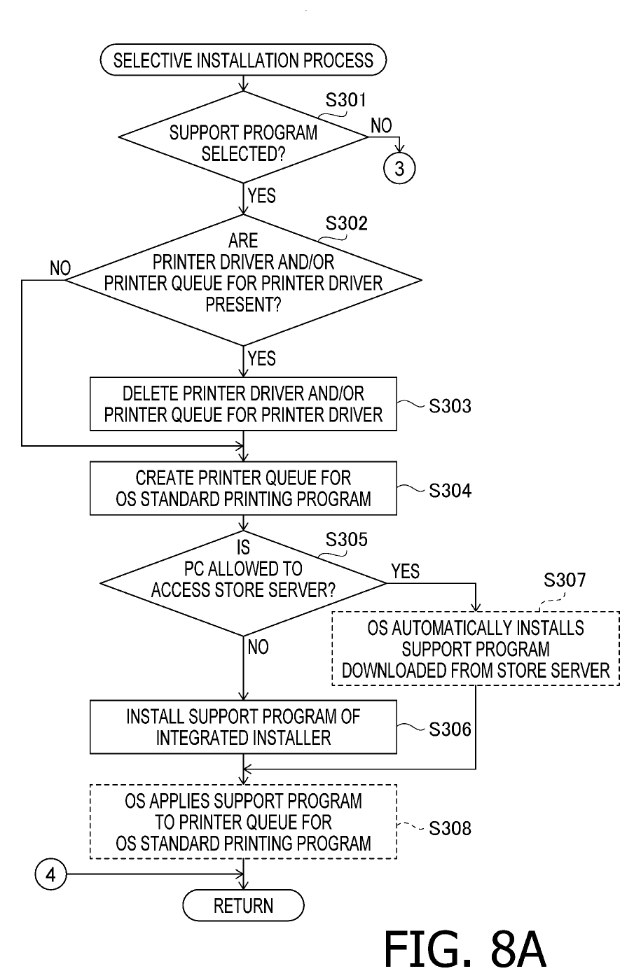

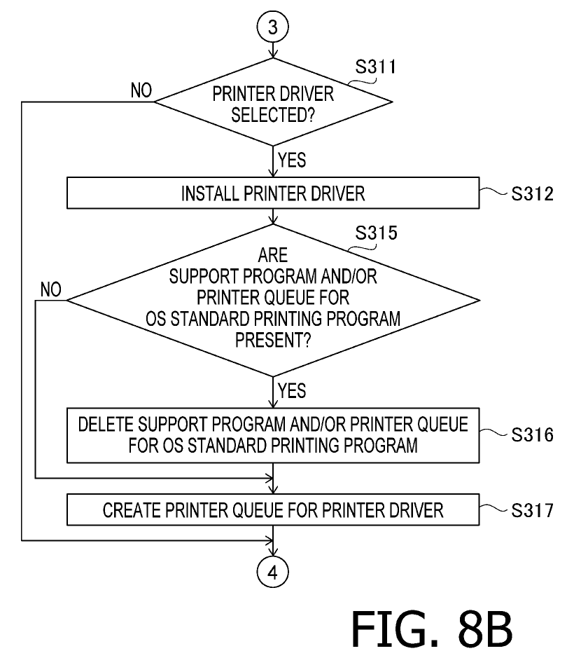

Returning to the description of the installation setting process shown in FIGS. 2A and 2B, after executing the program selection process (S111), the CPU 11 executes a selective installation process (S112). The selective installation process is a process in which, when the support program 222 or the printer driver 221 is determined as an installation target, the CPU 11 installs the determined program on the PC 1. A procedure of the selective installation process will be described with reference to FIGS. 8A and 8B.

In the selective installation process, the CPU 11 first determines whether the support program 222 has been selected as an installation target (S301). In response to determining that the support program 222 has been selected (S301: YES), the CPU 11 proceeds to S302 to determine whether at least one of a printer driver (e.g., the printer driver 221) for the printer 3 or a printer queue for the printer driver is present on the PC 1. In this case, in response to determining that at least one of a printer driver for the printer 3 or a printer queue for the printer driver is present (i.e., a printer driver has already been installed, and/or a printer queue for the printer driver has already been created) (S302: YES), the CPU 11 deletes the printer driver and/or the printer queue (S303). In another instance, the CPU 11 may determine in S302 whether a printer driver for the printer 3 is present on the PC 1. In this case, the CPU 11 may make an affirmative determination (S302: YES) if a printer driver for the printer 3 is present, regardless of whether a queue for the printer driver is present, and may make a negative determination (S302: NO) otherwise. In response to determining that a printer driver for the printer 3 is present (i.e., already installed) (S302: YES), the CPU 11 may proceed to S303 to delete the printer driver. At this time, if a printer queue for the printer driver has already been created, the CPU 11 may also delete the printer queue (S303).

As will be described later, before installation of each program, the CPU 11 may create a printer queue for the printer driver. The support program 222 is used together with the OS standard printing program 211 and does not coexist with the printer driver 221. That is, when the support program 222 is selected, the printer driver and the printer driver queue are unnecessary. Therefore, in response to receiving the selection of the support program 222, the CPU 11 deletes the printer driver and the printer driver queue. This configuration inhibits a situation in which the support program 222 is not installable.

After S303, or in response to determining in S302 that neither a printer driver for the printer 3 nor a printer queue for the printer driver exists (S302: NO), the CPU 11 creates a printer queue for the OS standard printing program 211 in association with the printer 3 (S304). Thus, by using the printer queue created in S304, the CPU 11 may, for instance, send a print job to the printer 3 using the OS standard printing program 211.

After S304, the CPU 11 proceeds to S305 to determine whether the PC 1 is allowed to access the store server 5 (see FIG. 1). For instance, depending on administrator settings, the PC 1 may be prohibited from accessing external networks or downloading from the store server 5. In such cases, the PC 1 is unable to access the store server 5. In response to determining that the PC 1 is not allowed to access the store server 5 (S305: NO), the CPU 11 installs the support program 222 included in the integrated installer 22 on the PC 1 (S306).

By including the support program 222 in the integrated installer 22 and installing the included support program 222 when the support program 222 is unable to be downloaded from the store server 5, it is possible to reduce the risk of failing to install the support program. When the support program 222 is installed from the integrated installer 22, the OS 21 does not automatically associate the installed support program 222 with the printer queue created in S304 for the OS standard printing program 211. Therefore, the integrated installer 22 incorporates into the PC 1 information for associating the installed support program 222 with the printer queue created in S304. As a result, the support program 222 and the printer queue created in S304 are associated with each other.

On the other hand, when the PC 1 is allowed to access the store server 5 (S305: YES), the CPU 11 determines that the support program 222 is downloadable from the store server 5 and does not execute S306. In this case, in response to the printer queue for the OS standard printing program 211 being created in S304, the OS 21 automatically installs the support program 222 corresponding to the created printer queue on the PC 1 (S307). In FIG. 8A and subsequent drawings, processing steps (e.g., automatic processes by the OS 21 and user operations) other than processes based on the integrated installer 22 are indicated by dashed lines.

The OS 21 of the PC 1 is configured to automatically incorporate the support program 222 corresponding to the printer 3, for instance, when a new printer queue for the OS standard printing program 211 corresponding to the printer 3 has been created. The OS 21 downloads an installer for the support program 222 from the store server 5 specified by the OS 21 and automatically installs the support program 222 on the PC 1. The OS 21 further automatically associates the installed support program 222 with the printer queue for the OS standard printing program 211.

Accordingly, after S306 or S307, the OS 21 applies the installed support program 222 to the printer queue created in S304 for the OS standard printing program 211 (S308). Thus, when the printer 3 is selected and the OS standard printing program 211 is executed, the OS standard printing program 211 is enabled to activate the support program 222 corresponding to the printer 3.

The support program 222 may also be obtained from an external device other than the store server 5. For instance, if the PC 1 is unable to access the store server 5, the support program 222 may be obtained via a network from an in-house management server or from the server 4 (see FIG. 1) operated by the vendor of the printer 3.

This configuration, in which the PC 1 may access an external server to download and install the latest support program when it is unable to access the store server 5, reduces the risk of failing to install the support program. For instance, in response to determining NO in S305 (S305: NO), the CPU 11 may attempt to access the external server before S306. If the CPU 11 fails to access the external server, the CPU 11 may then proceed to S306 to install the support program 222 included in the integrated installer 22. In another instance, when the CPU 11 is unable to access either the store server 5 or the external server, the CPU 11 may issue a warning that the support program has not been installed.

On the other hand, in response to determining that the support program 222 has not been selected (S301: NO), the CPU 11 determines whether the printer driver 221 has been selected (S311). In response to determining that the printer driver 221 has been selected (S311: YES), the CPU 11 installs the printer driver 221 included in the integrated installer 22 (S312). Thus, the printer driver 221 is selectable as an installation target, thereby allowing the user to selectively install either the printer driver 221 or the support program 222.

The CPU 11 then determines whether at least one of the support program 222 or a printer queue for the OS standard printing program 211 is present on the PC 1 (S315). In response to determining that at least one of the support program 222 or a printer queue for the OS standard printing program 211 is present (i.e., the support program 222 has already been installed and/or a printer queue for the OS standard printing program 211 has already been created) (S315: YES), the CPU 11 deletes the support program 222 and/or the printer queue for the OS standard printing program 211 (S316). The printer driver 221 does not coexist with the support program 222. Therefore, when the support program 222 has already been installed, the CPU 11 deletes the support program 222 and also deletes a printer queue for the OS standard printing program 211 if the printer queue has already been created, thereby inhibiting a situation where the printer driver 221 is not installable.

After S316, or in response to determining in S315 that neither the support program 222 nor a printer queue for the OS standard printing program 211 is present (S315: NO), the CPU 11 creates a printer queue for the printer driver 221 installed in S312, in association with the printer 3 (S317). As a result, when the printer 3 is selected for printing, the OS 21 activates the printer driver 221 corresponding to the printer queue created in S317.

After S308 or S317, or after determining that neither the support program 222 nor the printer driver 221 has been selected (S301: NO and S311: NO), the CPU 11 ends the selective installation process and returns to the installation setting process.

Returning to the description of the installation setting process shown in FIGS. 2A and 2B, after executing the selective installation process (S112), the CPU 11 installs other programs selected in the program selection process (S115). In addition, the CPU 11 registers necessary information in the OS 21 (S116) and ends the installation setting process.

Next, a case will be described in which a USB connection is selected as the connection method for the printer 3. In response to determining that a USB connection has been selected (S102: USB), the CPU 11 requests the user to connect the PC 1 to the printer 3 via USB (S121). The CPU 11 then waits until the PC 1 is connected to the printer 3 via USB by the user (S122).

When a device is connected to the PC 1 via USB, the OS 21 of the PC 1 automatically acquires information about the connected device. In this case, the connected device is the printer 3, which has a printing function. Therefore, the OS 21 determines that the connected device (i.e., the printer 3) is a device to be used for printing by the OS standard printing program 211, and automatically creates a printer queue for the OS standard printing program 211 in association with the printer 3 (S125).

Thereafter, the CPU 11 proceeds to S126 to determine whether the PC 1 is allowed to access the store server 5 (see FIG. 1). S126 is substantially the same process as S305 of the selective installation process. In response to determining that the PC 1 is allowed to access the store server 5 (S126: YES), the OS 21 automatically installs the support program 222, downloaded from the store server 5, corresponding to the printer queue created in S125 on the PC 1 (S127).

After S127, or in response to determining that the PC 1 is unable to access the store server 5 (S126: NO), the CPU 11 receives a selection of a target device for which various programs are to be installed on the PC 1 by the integrated installer 22 (S128). If only one device is connected to the PC 1 via USB, the CPU 11 may skip S128.

The CPU 11 then executes a program selection process (S129). The program selection process of S129 is substantially the same as the program selection process of S111. Through the program selection process of S129, the CPU 11 receives selections of programs to be installed.

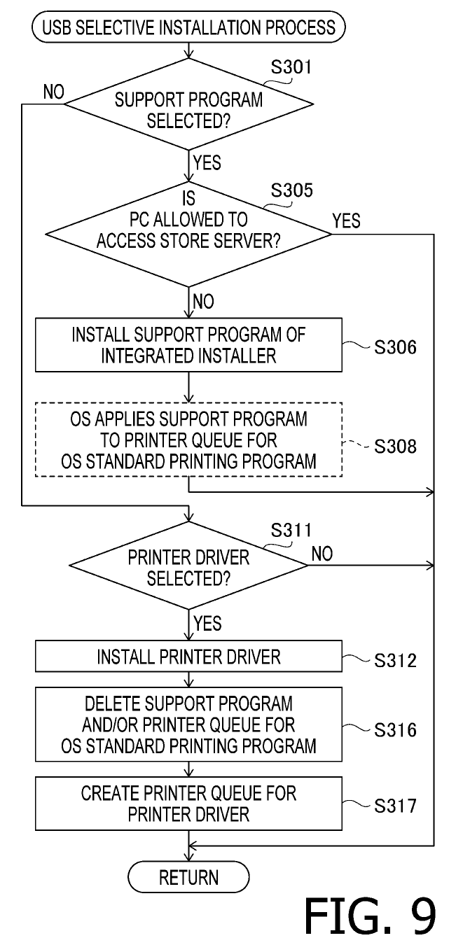

After executing the program selection process, the CPU 11 executes a USB selective installation process (S130). The USB selective installation process is similar to the selective installation process shown in FIGS. 8A and 8B. A procedure of the USB selective installation process will be described with reference to FIG. 9. In FIG. 9, the same reference numerals are assigned to substantially the same steps as those of the selective installation process shown in FIGS. 8A and 8B.

In the USB selective installation process, the CPU 11 determines whether the support program 222 has been selected as an installation target (S301). In response to determining that the support program 222 has been selected (S301: YES), the CPU 11 determines whether the PC 1 is allowed to access the store server 5 (S305).

In the USB connection, as described above, a printer queue for the OS standard printing program 211 is automatically created. Further, if the PC 1 is allowed to access the store server 5, the support program 222 is automatically installed on the PC 1. That is, when the support program has been selected in the program selection process, S302 to S304 of the selective installation process (see FIGS. 8A and 8B) do not need to be executed. In addition, if the PC 1 is allowed to access the store server 5, the support program 222 has already been installed on the PC 1. Therefore, in this case, S307 of the selective installation process (see FIGS. 8A and 8B) does not need to be executed.

On the other hand, when the PC 1 is not allowed to access the store server 5 (S305: NO), the support program 222 is not installed on the PC 1. In this case, as described above, the CPU 11 installs the support program 222 included in the integrated installer 22 (S306). In another instance, the CPU 11 may obtain the support program 222 from an external server. Thus, even when the printer 3 is used via a USB connection, the support program 222 is installed on the PC 1. As a result, the OS 21 applies the installed support program 222 to the printer queue for the OS standard printing program 211 (S308).

On the other hand, when the printer driver 221 has been selected in the program selection process (S301: NO and S311: YES), the CPU 11 installs the printer driver 221 included in the integrated installer 22 on the PC 1 (S312).

Further, the CPU 11 deletes the printer queue, created in S125 of the installation setting process, for the OS standard printing program 211. In addition, if the support program 222 has already been installed, the CPU 11 also deletes the support program 222.

The CPU 11 then creates, in association with the printer 3, a printer queue for the printer driver 221 installed in S312 (S317). As a result, the printer driver 221 corresponding to the printer queue created in S317 becomes usable for printing with the printer 3. After S308 or S317, or when the support program 222 has been selected and the PC 1 is allowed to access the store server 5 (S301: YES and S305: YES), or when neither the support program 222 nor the printer driver 221 has been selected (S301: NO and S311: NO), the CPU 11 ends the USB selective installation process and returns to the installation setting process.

It is noted that, when neither the support program 222 nor the printer driver 221 is selected in the program selection process, the CPU 11 deletes the support program 222 if the support program 222 has already been installed. In this case, the CPU 11 may or may not delete the printer queue for the OS standard printing program 211.

After the USB selective installation process, the CPU 11 installs other programs selected in the program selection process (S115). In addition, the CPU 11 registers necessary information in the OS 21 (S116) and ends the installation setting process. Thus, even when a USB connection is selected, either the support program or the printer driver becomes available depending on the user selection.

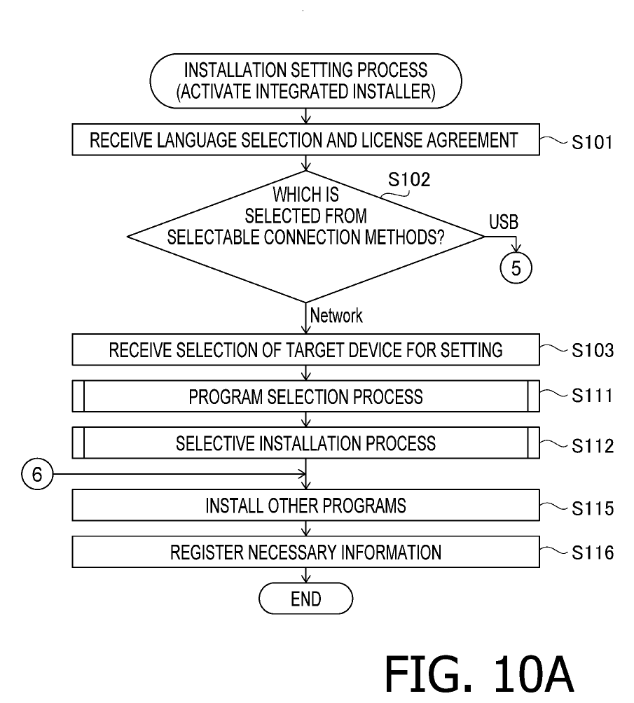

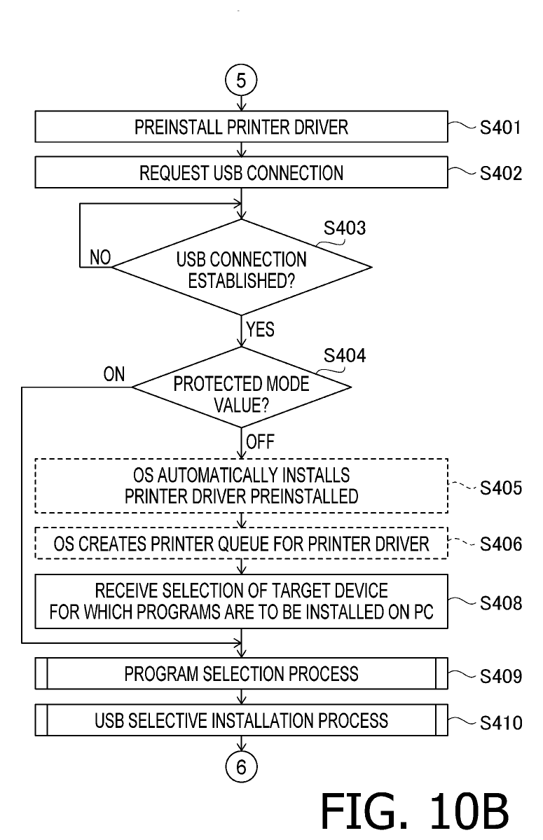

As a procedure after a USB connection has been selected (S102: USB), a procedure (see S401 to S410) in an installation setting process shown in FIGS. 10A and 10B may be applied instead of the procedure (see S121 to S130) in the installation setting process shown in FIGS. 2A and 2B. In the installation setting process shown in FIGS. 10A and 10B, when the PC 1 is connected to the printer 3 via USB, the OS 21 does not automatically create a printer queue for the OS standard printing program 211. In this respect, the installation setting process shown in FIGS. 10A and 10B differs from the installation setting process shown in FIGS. 2A and 2B, in which the OS 21 automatically creates a printer queue for the OS standard printing program 211. It is noted that, in the installation setting process shown in FIGS. 10A and 10B, the procedure after a network connection has been selected (S102: Network) is the same as that in the installation setting process shown in FIGS. 2A and 2B. Therefore, the description of the same procedure is omitted below. Hereinafter, only the procedure after a USB connection has been selected will be described.

In the installation setting process shown in FIGS. 10A and 10B, in response to determining in S102 that a USB connection has been selected (S102: USB), the CPU 11 proceeds to S401 to preinstall the printer driver 221 of the integrated installer 22. Thereafter, the CPU 11 requests the user to connect the PC 1 to the printer 3 via USB (S402). The CPU 11 then waits until the PC 1 is connected to the printer 3 via USB by the user (S403).

When the PC 1 is connected to the printer 3 via USB with the printer driver 221 preinstalled, the CPU 11 determines whether the protected mode value 212 is ON or OFF (S404). In response to determining that the protected mode value 212 is OFF (S404: OFF), the OS 21 automatically installs the preinstalled printer driver 221 on the PC 1 (S405). Further, the OS 21 creates a printer queue for the installed printer driver 221 (S406) and associates the created printer queue with the printer 3.

On the other hand, in response to determining that the protected mode value 212 is ON (S404: ON), the CPU 11 skips S405 and S406. That is, even if the printer driver 221 has been preinstalled, the OS 21 does not install the printer driver 221 on the PC 1, nor does it create a printer queue for the printer driver 221. In this case, the OS 21 may create a printer queue for the OS standard printing program 211.

Thereafter, the CPU 11 receives a selection of a target device for which various programs are to be installed on the PC 1 by the integrated installer 22 (S408). It is noted that S408 is substantially the same process as S128 of the installation setting process (see FIGS. 2A and 2B).

The CPU 11 then executes a program selection process (S409). The program selection process of S409 is substantially the same as the program selection process of S111 in the installation setting process (see FIGS. 2A and 2B).

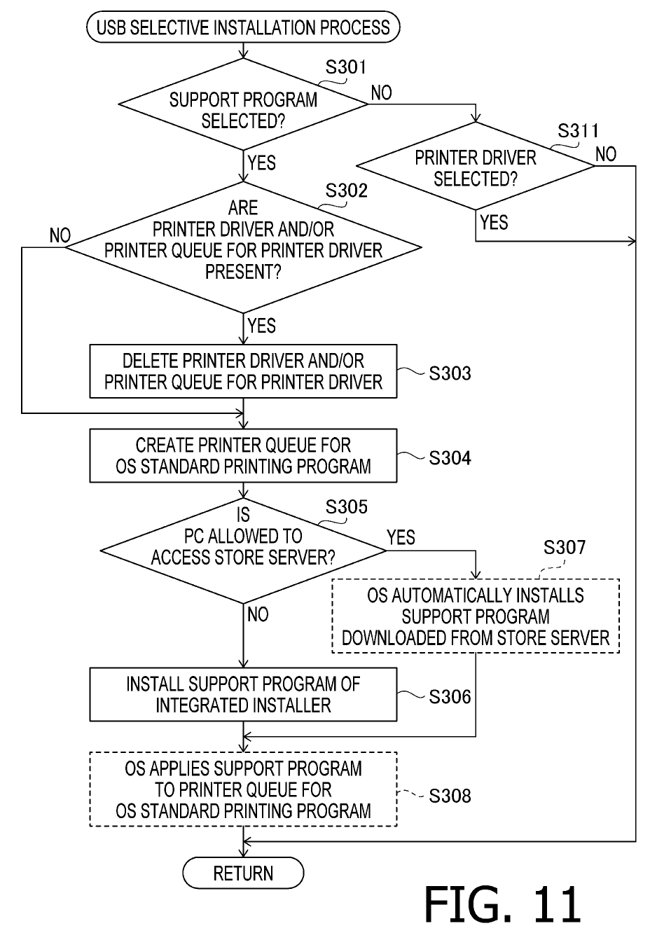

The CPU 11 then executes a USB selective installation process (S410). The USB selective installation process of S410 is similar to the selective installation process shown in FIGS. 8A and 8B. A procedure of the USB selective installation process executed in S410 will be described with reference to FIG. 11. In FIG. 11, the same reference numerals are assigned to substantially the same steps as those of the selective installation process shown in FIGS. 8A and 8B.

In the USB selective installation process shown in FIG. 11, the CPU 11 determines whether the support program 222 has been selected as an installation target (S301). In response to determining that the support program 222 has been selected (S301: YES), the CPU 11 deletes the printer driver 221 and/or a printer queue for the printer driver (S303) if at least one of them is present (S302: YES).

The CPU 11 then creates a printer queue for the OS standard printing program 211 (S304). Further, in response to determining that the PC 1 is not allowed to access the store server 5 (S305: NO), the CPU 11 installs the support program 222 of the integrated installer 22 on the PC 1 (S306). Meanwhile, in response to determining that the PC 1 is allowed to access the store server 5 (S305: YES), the OS 21 automatically installs the support program 222 on the PC 1 (S307).

On the other hand, in response to determining in the program selection process that the printer driver 221 has been selected (S301: NO and S311: YES), the CPU 11 ends the USB selective installation process. In the installation setting process shown in FIGS. 10A and 10B, the printer driver 221 has already been installed in S405, and a printer queue for the printer driver has already been created in S406. It is noted that, when the protected mode value 212 is ON, the printer driver 221 is not selectable in the program selection process, and therefore the CPU 11 does not make an affirmative determination in S311.

After the USB selective installation process (S410), the CPU 11 installs other programs selected in the program selection process (S115). In addition, the CPU 11 registers necessary information in the OS 21 (S116). Thereafter, the CPU 11 ends the installation setting process. In this way, either the support program 222 or the printer driver 221 becomes available depending on the user selection.

As described in detail above, the integrated installer 22 is configured to display the notification message 533 indicating that the support program 222 is to be installed, for instance, as illustrated in FIG. 6. In response to an operation on the “Next” button with the support program 222 selected as an installation target (e.g., in response to an operation on the “Next” button 532 in FIG. 6), the integrated installer 22 executes processing for installing the support program 222 on the PC 1. This enables installation of the support program 222 through a procedure different from the automatic installation procedure (e.g., the procedure of S127 in FIG. 2B) by the OS 21.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

For instance, the display configuration of each selection screen is merely an example and is not limited to the illustrated configuration. The shapes and arrangements of various buttons and the wording of messages are not limited to the illustrated examples and may take any form. In addition, although examples have been shown in which various notification messages are displayed on the corresponding selection screens, each notification message may also be displayed in a separate window from the selection screen or as a pop-up.

In the aforementioned illustrative embodiment, the integrated installer 22 has been described as including the support program 222. However, the integrated installer 22 may not necessarily include the support program 222. In such a case, when the PC 1 is unable to access the store server 5 or an external server, the user may request an administrator to permit access to the store server 5 or the external server, thereby obtaining the support program 222. The integrated installer 22 may be of a type that includes the support program 222 or a type that does not include it.

In the illustrative embodiment, the integrated installer 22 has been described as receiving a selection as to whether the support program 222 is to be installed when the protected mode value 212 is ON. However, the integrated installer 22 may also be configured to always install the support program 222 when the protected mode value 212 is ON. For instance, on the fourth selection screen 54, the CPU 11 may make it unchangeable that the support program 222 is selected as an installation target.

In addition, the group of programs to be installed when the standard installation is selected, the group of programs to be installed by default when the custom installation is selected, and the group of programs that are selectable as installation targets when the custom installation is selected are not limited to the examples presented in the aforementioned illustrative embodiment.

Further, in the aforementioned illustrative embodiment, the OS 21 has been described as Windows (“Windows” is a registered trademark of Microsoft Corporation). However, examples of the OS 21 may include macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

Moreover, in any of the flowcharts described in the aforementioned illustrative embodiment, a plurality of processes in a plurality of steps may be executed in an arbitrarily changed order or in parallel, as long as no contradictions arise in the processing content.

Furthermore, the processes described in the aforementioned illustrative embodiment may be executed by one or more CPUs, one or more hardware elements such as ASICs, or a combination of at least two of them. In addition, the processes described in the illustrative embodiment may be realized in various forms, such as by a non-transitory computer-readable storage medium storing programs for executing the processes, and by a method.

The following provides examples of associations between elements set forth in the aforementioned illustrative embodiment(s) and modification(s), and elements claimed according to aspects of the present disclosure. For instance, the PC 1 may be an example of an “information processing device” according to aspects of the present disclosure. The controller 10 may be an example of a “controller” according to aspects of the present disclosure. The CPU 11 may be an example of a “processor” according to aspects of the present disclosure. The user I/F 13 may be an example of a “user interface” according to aspects of the present disclosure. The memory 12 may be an example of a “non-transitory computer-readable storage medium” according to aspects of the present disclosure. The OS 21 may be an example of an “operating system (OS)” according to aspects of the present disclosure. The integrated installer 22 may be an example of “computer-readable instructions” according to aspects of the present disclosure. The support program 222 may be an example of a “support program” according to aspects of the present disclosure. The printer driver 221 may be an example of a “device driver” according to aspects of the present disclosure. The protected mode value 212 may be “setting information” according to aspects of the present disclosure. The standard installation, which is a method in which the integrated installer 22 automatically selects programs to be installed, may be an example of an “automatic selection mode” according to aspects of the present disclosure. The custom installation, which is a method in which the user selects programs to be installed via the user I/F 13, may be an example of a “manual selection mode” according to aspects of the present disclosure. The printer 3 may be an example of a “printing device” according to aspects of the present disclosure. The store server 5 may be an example of a “particular website” according to aspects of the present disclosure. The server 4 may be an example of an “external server” according to aspects of the present disclosure. S304 and S306 may be included in a “first process” according to aspects of the present disclosure. S312 may be included in a “second process” according to aspects of the present disclosure.

What is claimed is:

1. A non-transitory computer-readable storage medium storing computer-readable instructions that are executable by a processor of an information processing device comprising a user interface and an operating system (OS), the computer-readable instructions being different from the OS and configured to, when executed by the processor, cause the information processing device to:
receive a first operation via the user interface; and
in response to receiving the first operation via the user interface, perform a first process to install a support program on the information processing device, the support program being configured to support an OS standard printing program.

2. The non-transitory computer-readable storage medium according to claim 1,
wherein the computer-readable instructions are further configured to, when executed by the processor, cause the information processing device to:
cause the user interface to display first installation information indicating that the support program is specified as an installation target; and
after the first installation information is displayed, perform the first process in response to receiving the first operation via the user interface.

3. The non-transitory computer-readable storage medium according to claim 2,
wherein the computer-readable instructions are further configured to, when executed by the processor, cause the information processing device to:
cause the user interface to display second installation information indicating that a device driver is specified as the installation target, the device driver being configured to control a printing device and provided by a vendor of the printing device; and
after the second installation information is displayed, perform a second process to install the device driver on the information processing device, in response to a second operation performed via the user interface.

4. The non-transitory computer-readable storage medium according to claim 3,
wherein the computer-readable instructions are further configured to, when executed by the processor, cause the information processing device to:
cause the user interface to display an operation screen configured to receive an operation to exclusively select either the support program or the device driver as the installation target;
perform the first process and not perform the second process in response to the first operation with the support program selected as the installation target on the operation screen; and
perform the second process and not perform the first process in response to the second operation with the device driver selected as the installation target on the operation screen.

5. The non-transitory computer-readable storage medium according to claim 4,
wherein the computer-readable instructions are further configured to, when executed by the processor, cause the information processing device to:
determine whether an OS setting is enabled, the OS setting being a setting of the OS for restricting use of the device driver; and
cause the user interface to display the operation screen configured to make the support program selectable and the device driver not selectable as the installation target, when the OS setting is enabled.

6. The non-transitory computer-readable storage medium according to claim 5,
wherein the computer-readable instructions are further configured to, when executed by the processor, cause the information processing device to:
inquire of the OS whether the OS setting is enabled, thereby determining whether the OS setting is enabled based on a response from the OS.

7. The non-transitory computer-readable storage medium according to claim 5,
wherein the computer-readable instructions are further configured to, when executed by the processor, cause the information processing device to:
store setting information indicating whether the OS setting is enabled in a particular storage area managed by the OS; and
read the setting information from the particular storage area and determine whether the OS setting is enabled based on the read setting information.

8. The non-transitory computer-readable storage medium according to claim 5,
wherein the computer-readable instructions are further configured to, when executed by the processor, cause the information processing device to:
when the OS setting is enabled, cause the user interface to display restriction information indicating that the device driver is unavailable.

9. The non-transitory computer-readable storage medium according to claim 5,
wherein the computer-readable instructions are further configured to, when executed by the processor, cause the information processing device to:
when the OS setting is not enabled, cause the user interface to display restriction information indicating that the device driver becomes unavailable if the OS setting is enabled.

10. The non-transitory computer-readable storage medium according to claim 3,
wherein the computer-readable instructions are further configured to, when executed by the processor, cause the information processing device to:
after the second installation information is displayed, delete the support program if the support program has been installed on the information processing device, in response to the second operation performed via the user interface.

11. The non-transitory computer-readable storage medium according to claim 2,
wherein the computer-readable instructions are further configured to, when executed by the processor, cause the information processing device to:
after the first installation information is displayed, delete the device driver if the device driver has been installed on the information processing device, in response to the first operation performed via the user interface, the device driver being configured to control a printing device and provided by a vendor of the printing device.

12. The non-transitory computer-readable storage medium according to claim 1,
wherein the OS is configured to download the support program from a particular website and install the downloaded support program on the information processing device, in response to creation of a printer queue for the OS standard printing program, and
wherein the first process comprises creating the printer queue for the OS standard printing program.

13. The non-transitory computer-readable storage medium according to claim 12,
wherein the computer-readable instructions include the support program, and
wherein the first process comprises:
creating the printer queue for the OS standard printing program; and
when the support program is not downloadable from the particular website, reading the support program included in the computer-readable instructions and installing the read support program on the information processing device, and, when the support program is downloadable from the particular website, not reading the included support program.

14. The non-transitory computer-readable storage medium according to claim 12,
wherein the first process comprises:
creating the printer queue for the OS standard printing program; and
when the support program is not downloadable from the particular website, accessing an external server connected to the information processing device via a network, downloading the support program from the external server, and installing the downloaded support program on the information processing device, and, when the support program is downloadable from the particular website, not accessing the external server.

15. The non-transitory computer-readable storage medium according to claim 1,
wherein the computer-readable instructions are further configured to, when executed by the processor, cause the information processing device to:
cause the user interface to display a selection screen configured to receive a selection between a manual selection mode in which the installation target is selected via the user interface and an automatic selection mode in which the installation target is automatically selected; and
select the support program as the installation target when the automatic selection mode is selected on the selection screen and an OS setting is enabled, the OS setting being a setting of the OS for restricting use of a device driver, the device driver being configured to control a printing device and provided by a vendor of the printing device.

16. The non-transitory computer-readable storage medium according to claim 15,
wherein the computer-readable instructions are further configured to, when executed by the processor, cause the information processing device to:
when the automatic selection mode is selected on the selection screen and the OS setting is enabled, select the support program as the installation target and not select the device driver as the installation target; and
when the automatic selection mode is selected on the selection screen and the OS setting is not enabled, select the device driver as the installation target and not select the support program as the installation target.

17. A method implementable on a processor of an information processing device comprising a user interface and an operating system (OS), the method comprising:
receiving a first operation via the user interface; and
in response to receiving the first operation via the user interface, performing a first process to install a support program on the information processing device, the support program being configured to support an OS standard printing program.

18. The method according to claim 17, further comprising:
causing the user interface to display first installation information indicating that the support program is specified as an installation target; and
after the first installation information is displayed, performing the first process in response to receiving the first operation via the user interface.

19. An information processing device comprising:
a user interface; and
a controller comprising an operating system (OS), the controller being configured to:
receive a first operation via the user interface; and
in response to receiving the first operation via the user interface, perform a first process to install a support program on the information processing device, the support program being configured to support an OS standard printing program.

20. The information processing device according to claim 19,
wherein the controller is further configured to:
cause the user interface to display first installation information indicating that the support program is specified as an installation target; and
after the first installation information is displayed, perform the first process in response to receiving the first operation via the user interface.
